(19) United States
(12) Patent Application Publication
(10) Pub. No.: US 2017/0305621 A1
(43) Pub. Date: Oct. 26, 2017

(54) COHESIVE ELASTIC DECORATIVE WRAPPING FILM

(71) Applicant: Jeffrey Miller, Attleboro, MA (US)

(72) Inventor: Jeffrey Miller, Attleboro, MA (US)

(21) Appl. No.: 15/490,951

(22) Filed: Apr. 19, 2017

Related U.S. Application Data
(60) Provisional application No. 62/325,181, filed on Apr. 20, 2016.

(51) Int. Cl. B65D 65/22; B32B 27/36; B65D 65/40; B65D 65/46; B65B 67/08; B32B 3/06; B65D 83/08; B32B 27/32; B65D 65/16

(52) U.S. Cl. CPC B65D 65/22; B32B 27/32; B32B 27/36; B65D 65/40; B65D 65/16; B65B 67/08; B32B 3/06; B65D 83/0841; B65D 65/466; B32B 2307/41; B32B 2307/51; B32B 2405/00; B32B 2553/00

(57) ABSTRACT

A decorative wrapping film for wrapping and concealing a gift is elastic, cohesive and opaque and printed upon. Decorative features such as colors, patterns, decals, text and images are presented on a decorative side of the film. The surface of a non-decorative side has cohesive properties, i.e. tending to attach, cling or adhere to at least the decorative side of the wrapping film. The wrapping film may be wound into a roll and mounted on a hand-held dispenser or set into a box dispenser. The cohesive properties mitigate the need for adhesive tapes when wrapping gifts. The elastic properties facilitate wrapping of edges, corners and irregularly shaped objects. Further, the direction in which the wrapping film is formed to the item may be changed by stretching and bending the wrapping film.

### CROSS-REFERENCE TO RELATED APPLICATIONS

This application claims the benefit of U.S. Provisional Patent Application 62/325,181, titled Eco-Friendly Gift Wrap Cling Film, filed on Apr. 20, 2016, which is incorporated by reference.

### BACKGROUND

The custom of wrapping gifts with decorative paper that conceals the gift may have started in China as long ago as the second century BC. In the Victorian era gifts were wrapped with elaborately decorated paper, ribbons and lace to conceal the gifts. Colored tissue paper was used to wrap and conceal gifts in the early 1900s. Decorative wrapping paper was traditionally held in place around the gift with a ribbon. It is now common to secure wrapping paper in place around the gift with clear adhesive tape. Nevertheless, ribbons are still used for decorative purposes.

The task of wrapping a gift can be time-consuming and tedious. In order to wrap a gift the wrapping paper is first cut to an appropriate size for the gift. For example, a piece of wrapping paper may be cut from a roll. The cut piece of wrapping paper is then formed around the gift by making various folds to conform to the shape of the gift. The edges of the wrapping paper are typically folded under and taped to provide a neat appearance and secure the wrapping paper in place. The cuts and folds must be carefully planned and executed in order for the wrapping paper to fit snugly around the gift with neat corners and edges.

Another problem with wrapping paper is creation of waste material. When the gift is opened the wrapping paper is removed and discarded. Approximately one million tons of wrapping paper waste is created each year in the United States in association with gifts wrapped during the Christmas holiday season alone. At least some wrapping paper is made with inks, films or finishes that are ecologically unfriendly or toxic.

### SUMMARY

All examples, aspects and features mentioned in this document can be combined in any technically possible way.

In accordance with an aspect an apparatus comprises an opaque wrapping film comprising a decorative side and a non-decorative side, the non-decorative side being cohesive and the decorative side comprising decorative features, the wrapping film comprising at least one elastic layer. In some implementations the non-decorative side reversibly attaches, clings or adheres to the decorative side. Some implementations comprise an adhesive layer disposed on the elastic layer. Some implementations comprise miniaturized mechanical fasteners disposed on the elastic layer. In some implementations the at least one elastic layer comprises a cohesive layer and a decorative layer laminated thereto. In some implementations the decorative features comprise decals. In some implementations the decorative features comprise ink. In some implementations the wrapping film is biodegradable. In some implementations the wrapping film is compostable. In some implementations the elastic layer comprises a cohesive energy in a range of 0.15 cm-gm to 0.4 cm-gm. Some implementations comprise perforations formed in the wrapping film. In some implementations the wrapping film is wound around a core to provide a roll. Some implementations further comprise a dispenser with a slotted cylinder that secures the roll and a handle for manipulating the roll. In some implementations the elastic layer comprises a material selected from a group consisting of: polyester, LLDPE (linear low-density polyethylene), PLA (polylactic acid), BOPP (biaxially oriented polypropylene), VpCl (multimetal vapor phase corrosion inhibitors), PoF (polyolefin), and PBAT (polybuterate). In some implementations the ink comprises a material selected from a group consisting of: water-based inks, water-based EB (electron beam) or UV (ultraviolet) cured inks, WetFlex and offset EB and UV cured inks.

In accordance with an aspect an apparatus comprises: an opaque elastic wrapping film comprising a cling layer and a print layer laminated therewith, the cling layer forming a non-decorative side of the wrapping film and the print layer forming a decorative side of the wrapping film, wherein the non-decorative side reversibly attaches, clings or adheres to the decorative side, and wherein the decorative side comprises decorative features printed with ink. In some implementations the wrapping film is biodegradable. In some implementations the wrapping film is compostable.

### BRIEF DESCRIPTION OF THE DRAWINGS

FIG. 1 illustrates a sheet of opaque cohesive elastic decorative wrapping film.

FIG. 2A illustrates a cohesive elastic decorative wrapping film that includes an adhesive layer on a film substrate.

FIG. 2B illustrates a cohesive elastic decorative wrapping film that includes miniaturized mechanical fasteners on a film substrate.

FIG. 2C illustrates a cohesive elastic decorative wrapping film that includes laminated cling and print layers.

FIG. 3 illustrates a roll of cohesive elastic decorative wrapping film.

FIG. 4 illustrates a dispenser for the cohesive elastic decorative wrapping film roll of FIG. 3.

FIGS. 5 and 6 illustrate wrapping of a gift using the dispenser and cohesive elastic decorative wrapping film roll.

FIG. 7 illustrates a roll of cohesive elastic decorative wrapping film in a box dispenser.

### DETAILED DESCRIPTION

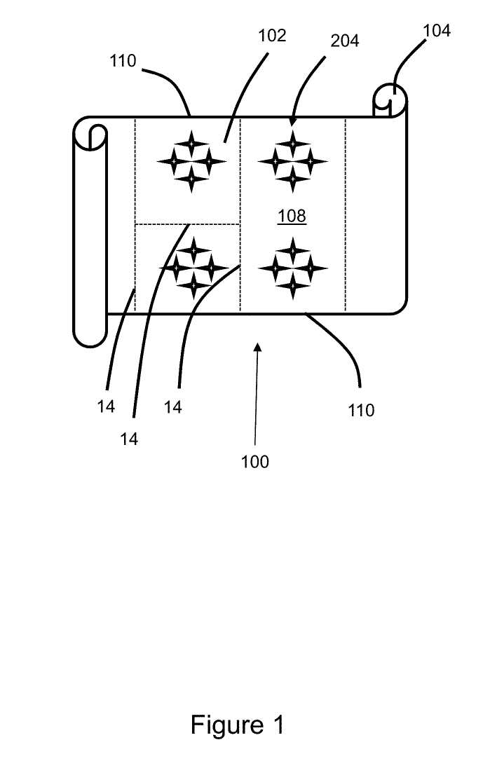

FIG. 1 illustrates a sheet of cohesive elastic decorative wrapping film 100. The cohesive elastic decorative wrapping film secures to itself and possibly to other surfaces, thereby mitigating or obviating the need for adhesive tape when wrapping a gift or other item. Moreover, the elasticity of the decorative wrapping film may facilitate wrapping of edges, corners and irregular surfaces and shapes. Unlike films used for packaging and transport, the wrapping film is opaque and includes aesthetic features such as patterns, colors, text, decals and images.

In the illustrated example the sheet of cohesive elastic decorative wrapping film 100 has a decorative side 102 and a non-decorative side 104. The surface of the non-decorative side 104 has cohesive properties, i.e. tending to attach, cling or adhere to at least the decorative side of the wrapping film sheet. In some implementations the non-decorative side 104 attaches, clings or adheres to the decorative side 102 of the sheet but not to the non-decorative side. In some implementations the non-decorative side 104 attaches, clings or adheres to other surfaces, possibly including but not limited to cardboard, plastic and other common packaging materials. It should be understood that the cohesive properties may be selected to enable the non-decorative side 104 to be removed from the surface to which it attaches, clings or adheres. For example, overlapping pieces of the decorative wrapping film sheet may be repeatedly attached, clung or adhered to each other and separated and repositioned until a secure and aesthetically pleasing result is attained. Nevertheless, permanent attachments and adhesives should not be viewed as being excluded from all implementations.

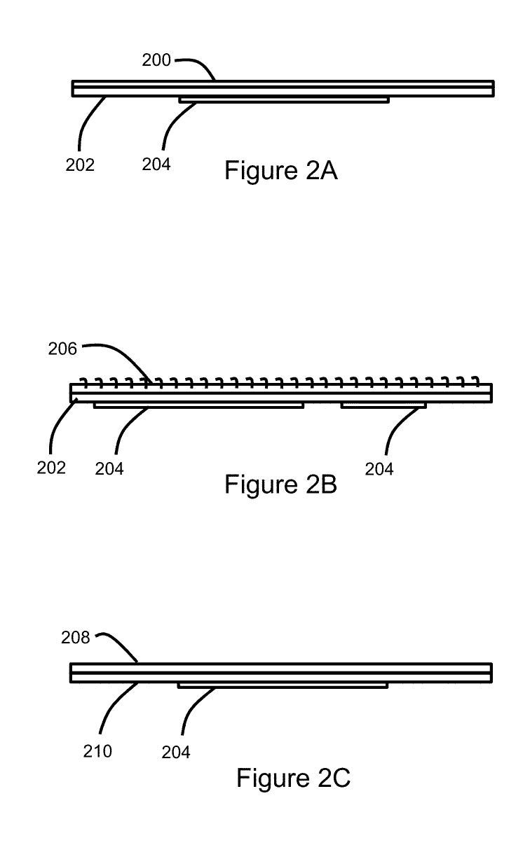

Suitable cohesive properties may be based on a variety of physical principles. For example and without limitation, an adhesive layer 200 may be applied to a substrate layer 202 to create the non-decorative side of the sheet as shown in FIG. 2A. Decorative features 204 may be applied to a surface of the substrate layer 202 opposite to the adhesive layer. Alternatively or additionally, a layer of miniaturized mechanical fasteners 206 could be applied to the substrate layer 202 to form the non-decorative side of the sheet as shown in FIG. 2B. Examples of mechanical fasteners that may be applied to the non-decorative side may include but are not limited to interlocking joints and hook and loop types. Again, decorative features 204 may be applied to a surface of the substrate layer 202. Alternatively or additionally a cling layer 208 substrate and print layer 210 substrate may be laminated as shown in FIG. 2C. The cling layer may cohesively cling on the basis of electrostatic charge and serve as the non-decorative side. The decorative side may include, in any combination, decorative features 204 and one or more print layers 210 laminated with to the cling layer 202 such that the decorative side and the non-decorative side have opposite electrostatic charges that attract. For example, print layer 210 may be an intermediate film layer that provides a suitable substrate for the decorative features 204. Alternatively or additionally, the print layer 210 may incorporate decorative aspects, for example and without limitation one or more colors and patterns. Cohesion can be expressed as the energy in cm-gms required to peel a 3½ inch wide by 4 inch long film specimen from a glass plate when using the test procedure outlined in ASTM D903-49, titled “Test For Peel Strengths of Adhesives.” Flexible film having a cohesive energy of between about 0.15 and about 0.4 cm-gm are suitable for use in cohesive wrapping paper, and in some implementations a cohesive energy of between about 0.2 and 0.3 cm-gm may be preferable.

Examples of films that may be used for the substrate (including cling and print) layers may include but are not limited to polyester, LLDPE (linear low-density polyethylene), PLA (polylactic acid), BOPP (biaxially oriented polypropylene), VpCl (multimetal vapor phase corrosion inhibitors), PoF (polyolefin), and PBAT (polybuterate).

Implementations may include a wide variety of elastic properties. Although elastic deformation of the decorative wrapping film is described herein, plastic deformation may be suitable in some implementations. The wrapping film and substrate layers in at least some implementations may have a 3:1 stretch ratio or ultimate elongation of 580/820%.

Referring collectively to FIGS. 2A, 2B and 2C, the decorative features 204 may include decals, inks, pattern cut colored layers that are used to form one or more colors, images, words, patterns and other features. The decorative features may be formed on an outer layer 202 or on a cling layer 208. Alternatively, or additionally, the decorative features may be applied to or incorporated into a single intermediate layer or multiple laminated intermediate substrate layers of different films. In other words, the decorative features may be implemented in any of a wide variety of combinations. The decorative wrapping film could be translucent but will typically be opaque. Unlike clear packaging films that are designed to enable the wrapped materials to be viewed through the film, it is generally preferred by consumers that gifts are hidden from view so that the recipient will not be able to identify the gift until it is unwrapped. Further, elaborate decorative patterns may be preferable to, e.g., a single solid color.

Examples of inks may include but are not limited to water-based inks, water-based EB (electron beam) or UV (ultraviolet) cured inks, WetFlex and offset EB and UV cured inks. Water-based inks are suitable for lamination, flexo and gravure printing, and can be printed on existing presses and are an option for process printing. Water-based EB cured inks are suitable for surface print with good resolubility. The inks have excellent resistance properties from EB cross linking and are available for non-food applications. WetFlex provides gravure quality high speed printing. Offset EB cured inks are suitable for fast turnaround and short-runs, with low cost plates, based on the extended gamut concept.

In some implementations the sheet of wrapping film may have a thickness dimension from 0.25 mil (0.006 mm) to about 1.25 mils (0.031 mm), and length and width dimensions that are adequate to wrap a gift or other item having a predetermined size. The thickness may be selected based on desired strength, opacity and other factors.

In some implementations the decorative wrapping film is made from one or more layers of biodegradable and/or compostable film. Further, the inks, if any, may be non-toxic and biodegradable and/or compostable. Further, the adhesive, if any, may be biodegradable and/or compostable. As defined herein, a material is biodegradable if it will completely break down, i.e. decompose into substances found in nature, within a reasonably short period of time after customary disposal and in the presence of adequate moisture. This may occur because the material disintegrates into small pieces and is consumed by micro-organisms. For an article of manufacture to be marked compostable there must be scientific evidence that the component materials of the article break down, or become part of, usable compost in a safe and timely manner in an appropriate composting facility or home compost pile. Compostable materials break down into “humus,” which may provide valuable nutrients to the soil. Biodegradable products return to nature, disintegrating or disappearing completely. The process of biodegrading may be longer than the process of composting, e.g. years as opposed to months. Compostable items must completely break down and not release any metals or toxins into the compost, whereas biodegradable products can leave metal residue in their return to nature.

Referring again to FIG. 1, perforations 14 may be formed in the decorative wrapping film sheet 100. For example and without limitation, the perforations may be formed at regular or irregular intervals such that a piece, e.g. piece 108, of decorative wrapping film having a desired length, width, or both can be separated from the sheet without scissors or other cutting tools. For example, a perforation may extend between opposite edges 110 along the length of the sheet and a perforation may extend between adjacent parallel perforations 14.

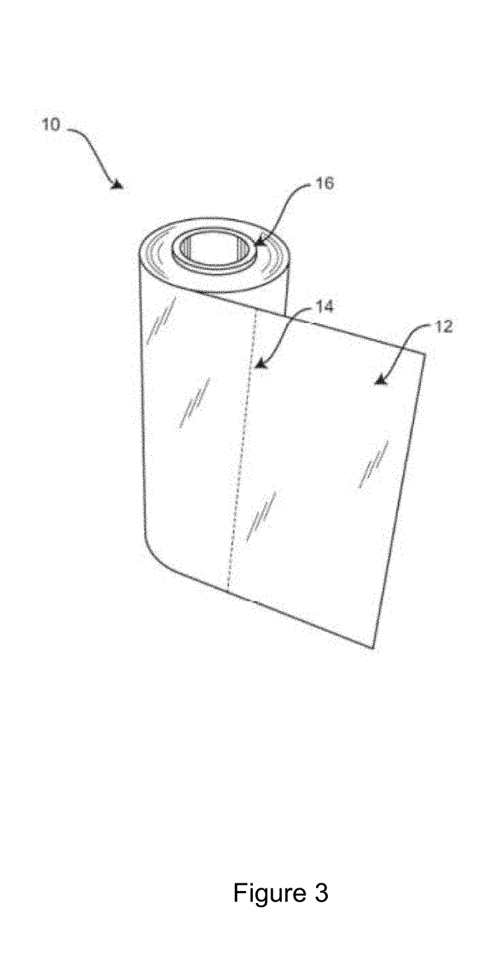

Referring now to FIG. 3, a decorative wrapping film roll 10 includes a sheet 12 of cohesive elastic decorative wrapping film wound around a core 16. The core 16 may be paperboard or other material. In some implementations the core 16 is biodegradable and/or compostable. As mentioned above, perforations 14 may be formed to facilitate separation of a piece of decorative wrapping film from the roll.

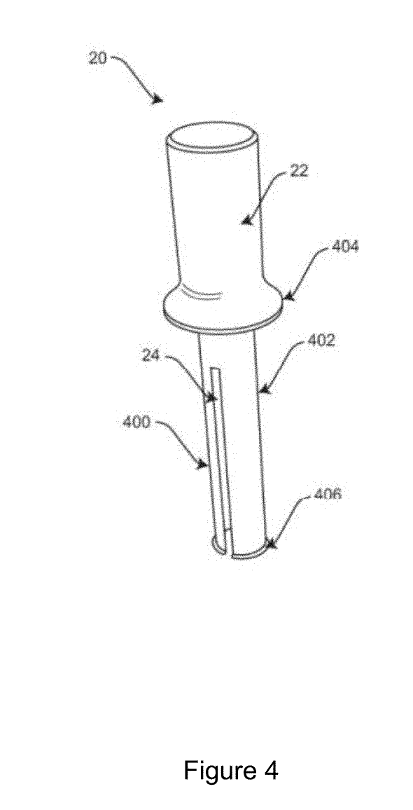

FIG. 4 illustrates a dispenser 20 for use with the cohesive elastic decorative wrapping film roll 10 shown in FIG. 3. The dispenser 20 includes a slotted cylinder 400 with an outside diameter that is less than or equal to the inside diameter of the core 16. An outer surface of the slotted cylinder may include protuberances 402 or other features to provide friction between the outer surface of the slotted cylinder and an inner surface of the core 16. The friction may help to prevent the roll of decorative wrapping film from freely rotating around the slotted cylinder and unraveling. Further, the friction may cause the decorative wrapping film to remain taught or slightly stretched as the decorative wrapping film is applied to a gift or other item, e.g. by moving the handle 22 relative to the gift such that the decorative wrapping film roll rotates around the slotted cylinder 400 as decorative wrapping film is dispensed. Flanges 404, 406 at distal ends of the slotted cylinder 400 prevent the core 16 and roll from sliding away from the slotted cylinder. At least one slot 24, e.g. and without limitation two slots offset by 180 degrees, extending along a portion of the length of the cylinder 400, thereby enabling the cylinder to be compressed to temporarily decrease the diameter in order to facilitate mounting or demounting of the roll by inserting the cylinder into the core. When compressing force is removed from the slotted cylinder it resumes its original shape and diameter. The handle 22 disposed at a distal end of the cylinder 400 provides a convenient hand-hold for manipulating the decorative wrapping film roll mounted on the dispenser. The handle also facilitates interchangeability between rolls of film.

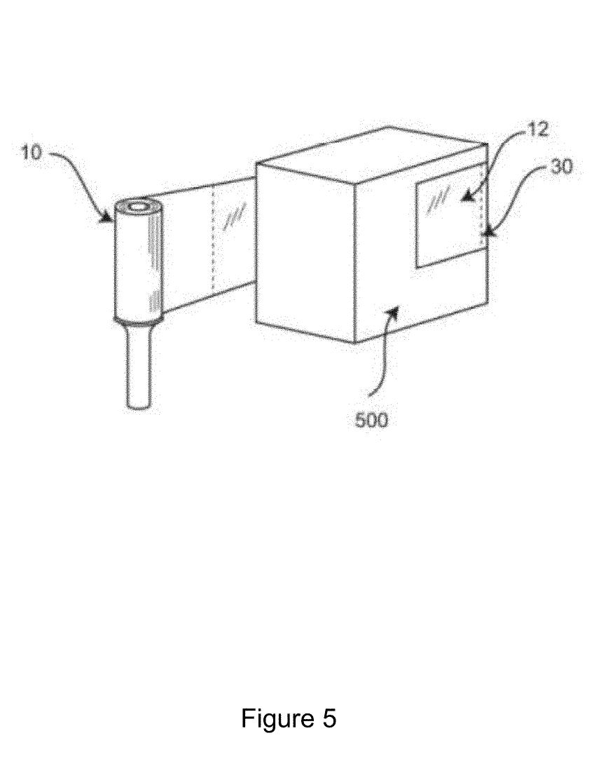

Referring now to FIG. 5, in order to wrap an item 30 a free distal end 500 of the decorative wrapping film 12 is placed against a surface of the item. The free distal end may be held in place manually or secured with a tape or adhesive, neither of which may be required if the non-decorative surface clings, adheres or fastens to the surface of the item. Having secured the free distal end to the surface of the item, the decorative wrapping film is unrolled under tension to form the decorative wrapping film around the item 30. Because the decorative wrapping film is elastic it may be deformed (stretched) as it is formed around the item 30. The decorative wrapping film may be formed around the item until it overlaps the distal end 500, after which it may be separated from the roll 10, e.g. by tearing along a perforation. The process may be repeated with different starting locations of free distal ends of the decorative wrapping film until the item is completely wrapped. The decorative side of the decorative wrapping film, which is outward facing from the wrapped item 30, may have a color, pattern, or no pattern, such that overlaps are aesthetically acceptable. Because the decorative wrapping film is cohesive it may not be necessary to fold over (turn under) the cut edges of the decorative wrapping film.

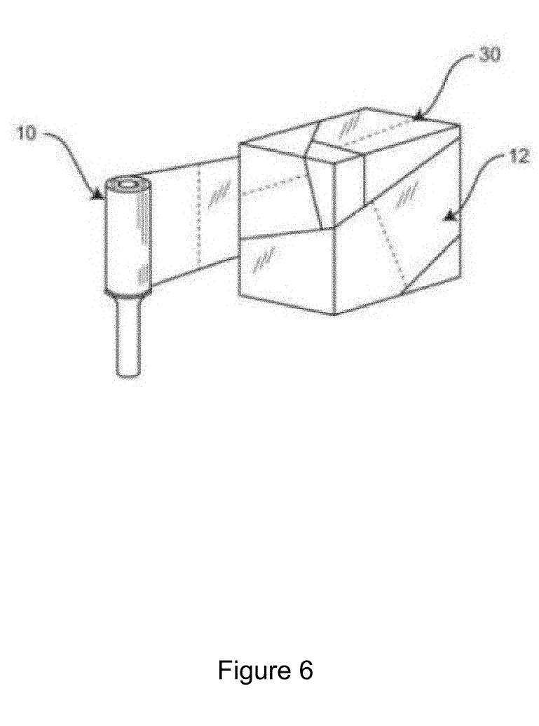

Referring now to FIG. 6, because the decorative wrapping film 12 is cohesive and elastic it may be possible to change the direction in which the decorative wrapping film is formed around the item 30. Consequently, rather than wrapping the item with separate strips of decorative wrapping film it may be possible to form a continuous strip of decorative wrapping film around the item. As mentioned above, the pattern, or lack thereof, of the decorative side may be selected such that random overlaps are aesthetically acceptable.

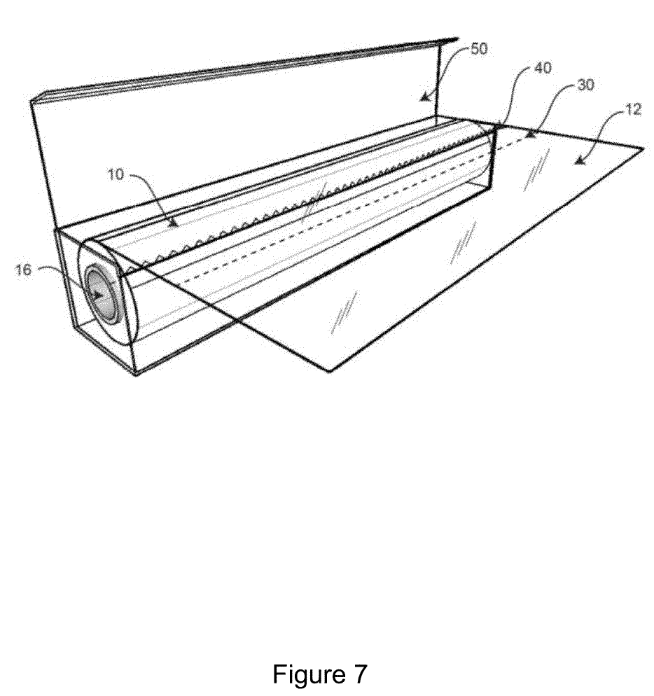

Referring to FIG. 7, in some implementations the roll 10 of decorative wrapping film 12 is disposed in an elongated box 50. The box may have a length dimension corresponding to the length of the core 16. The decorative wrapping film may be dispensed through a slot or other opening in the box. More particularly, the roll rotates within the box as the film is pulled away from the roll. The box may be equipped with a sharp serrated cutting edge 40 for use in cutting the decorative wrapping film. For example, a piece of decorative wrapping film may be pulled away from the roll and cut at a desired length using the cutting edge.

A number of features, aspects and implementations have been described. Nevertheless, it will be understood that a wide variety of modifications and combinations may be made without departing from the scope of the inventive concepts described herein. Accordingly, those modifications and combinations are within the scope of the following claims.

What is claimed is:

1. An apparatus comprising:
an opaque wrapping film comprising a decorative side and a non-decorative side, the non-decorative side being cohesive and the decorative side comprising decorative features, the wrapping film comprising at least one elastic layer.

2. The apparatus of claim 1 wherein the non-decorative side reversibly attaches, clings or adheres to the decorative side.

3. The apparatus of claim 1 comprising an adhesive layer disposed on the elastic layer.

4. The apparatus of claim 1 comprising miniaturized mechanical fasteners disposed on the elastic layer.

5. The apparatus of claim 1 wherein the at least one elastic layer comprises a cohesive layer and a decorative layer laminated thereto.

6. The apparatus of claim 1 wherein the decorative features comprise decals.

7. The apparatus of claim 1 wherein the decorative features comprise ink.

8. The apparatus of claim 1 wherein the wrapping film is biodegradable.

9. The apparatus of claim 1 wherein the wrapping film is compostable.

10. The apparatus of claim 1 wherein the elastic layer comprises a cohesive energy in a range of 0.15 cm-gm to 0.4 cm-gm.

11. The apparatus of claim 1 comprising perforations formed in the wrapping film.

12. The apparatus of claim 1 wherein the wrapping film is wound around a core to provide a roll.

13. The apparatus of claim 12 further comprising a dispenser with a slotted cylinder that secures the roll and a handle for manipulating the roll.

14. The apparatus of claim 1 wherein the elastic layer comprises a material selected from a group consisting of: polyester, LLDPE (linear low-density polyethylene), PLA (polylactic acid), BOPP (biaxially oriented polypropylene), VpCl (multimetal vapor phase corrosion inhibitors), PoF (polyolefin), and PBAT (polybuterate).

15. The apparatus of claim 7 wherein the ink comprises a material selected from a group consisting of: water-based inks, water-based EB (electron beam) or UV (ultraviolet) cured inks, WetFlex and offset EB and UV cured inks.

16. An apparatus comprising:
an opaque elastic wrapping film comprising a cling layer and a print layer laminated therewith, the cling layer forming a non-decorative side of the wrapping film and the print layer forming a decorative side of the wrapping film, wherein the non-decorative side reversibly attaches, clings or adheres to the decorative side, and wherein the decorative side comprises decorative features printed with ink.

17. The apparatus of claim 16 wherein the wrapping film is biodegradable.

18. The apparatus of claim 16 wherein the wrapping film is compostable.
